(19) United States
(12) Patent Application Publication
(10) Pub. No.: US 2013/0275852 A1
(43) Pub. Date: Oct. 17, 2013

(54) METHOD FOR ACCESSING INFORMATION ON THE INTERNET AND ELECTRONIC DEVICE HAVING INTERNET ACCESS FUNCTION

(71) Applicants: Xin LU, Shenzhen City (CN); Yao-Hua LIU, Shenzhen City (CN)

(72) Inventors: Xin LU, Shenzhen City (CN); Yao-Hua LIU, Shenzhen City (CN)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/531,157

(22) Filed: Jun. 22, 2012

(30) Foreign Application Priority Data
Apr. 11, 2012 (CN) 201210103978.1

(51) Int. Cl. G06F 17/00

(52) U.S. Cl. 715/234

(57) ABSTRACT

A computerized method accesses information on the Internet from a network server using an electronic device. An initial viewable area of a webpage to be displayed on a display screen is calculated, when the electronic device requests to access the webpage using a web browser. Information within the initial viewable area of the webpage is requested and displayed on the display screen through the web browser. Movements of a horizontal scrollbar and a vertical scrollbar of the web browser are monitored in real-time. A current viewable area of the webpage is calculated when a movement of the horizontal scrollbar or the vertical scrollbar is monitored. Information within the current viewable area of the webpage is requested from the network server to update information displayed on the display screen.

### BACKGROUND

1. Technical Field

Embodiments of the present disclosure relate to Internet access technologies, and particularly to a method for accessing information on the Internet and an electronic device having Internet access functions.

2. Description of Related Art

Many electronic devices such as panel computers and smart phones are installed with a web browser to enable users to access, retrieve and view information on the Internet. When a webpage on the Internet is accessed by the web browser, all information on the webpage may be downloaded to and temporarily stored in the electronic device, so that the user can view his/her required information from the webpage. However, some or portion of the downloaded information may not be useful for the user and may never be viewed. Therefore, the method for accessing the webpage by downloading all information of the webpage may be time consuming and a waste of network resources, especially when the webpage includes a lot of unwanted information having a large size, such as images and videos.

### BRIEF DESCRIPTION OF THE DRAWINGS

FIG. 1 is a schematic block diagram illustrating one embodiment of an electronic device accessing a network server through a network.

FIG. 2 is a schematic diagram of an initial viewable area of a webpage accessed by the electronic device.

FIG. 3 is a schematic diagram of a current viewable area of the webpage.

FIG. 4 is a flowchart of one embodiment showing a method for accessing information on the Internet from the network server using the electronic device 1 of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

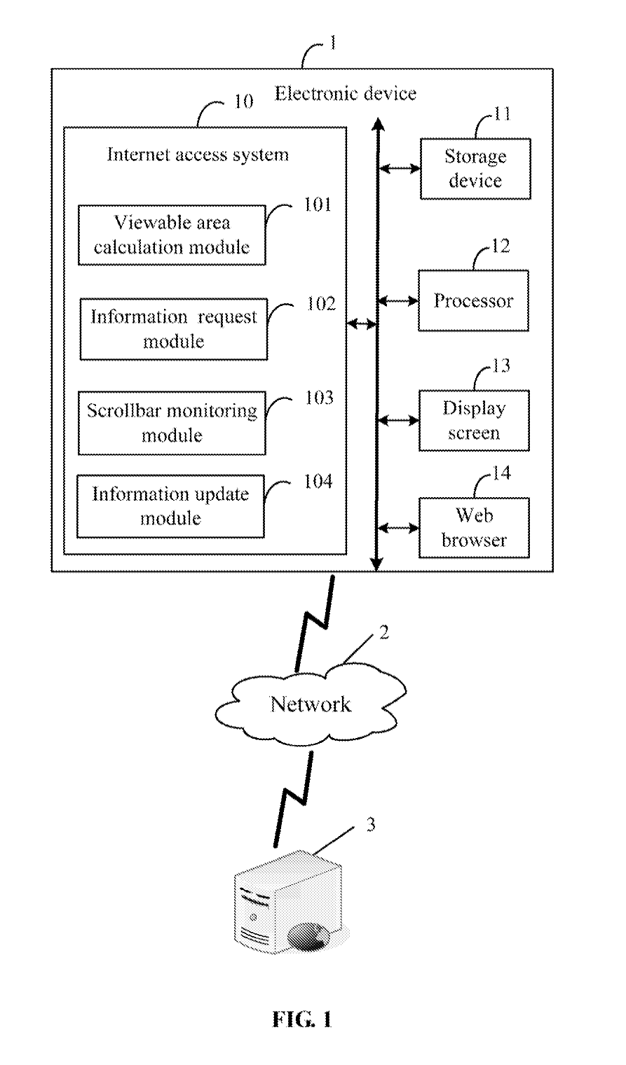

FIG. 1 is a schematic block diagram illustrating one embodiment of an electronic device 1 accessing a network server 3 through a network 2. The electronic device 1 can obtain various information on the Internet from the network server 3. The electronic device 1 may be a panel computer, a smart phone, a mobile internet device, or other similar device. The network 2 may be a wireless network or a wired network.

The electronic device 1 includes an Internet access system 10, a storage device 11, at least one processor 12, a display screen 13, and a web browser 14. The Internet access system 10 is executed by the at least one processor 12 for accessing information on the Internet through the network 2. The Internet access system 10 may include a plurality of programs in the form of one or more computerized instructions stored in the storage device 11 and executed by the at least one processor 12 to perform operations of the electronic device 1. In the embodiment, the Internet access system 10 includes a viewable area calculation module 101, an information request module 102, a scrollbar monitoring module 103, and an information update module 104. FIG. 1 shows one example of the electronic device 1, and the electronic device 1 can include more or fewer components than those shown in the embodiment, or have a different configuration of the components.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The viewable area calculation module 101 calculates an initial viewable area of a webpage to be displayed on the display screen 13, when the electronic device 1 requests to access the webpage from the network server 3 using the web browser 14. In the embodiment, the viewable area is defined as a portion of the webpage that is to be displayed on the display screen 13 through the web browser 14. The viewable area is calculated according to a display size of the display screen 13, positions of a horizontal scrollbar and a vertical scrollbar of the web browser 14, and a width and a height of the webpage. The display size of the display screen 13 is defined as a rectangular screen space having a width and a height that is available to display data, such as pictures, videos or working spaces. The display size may be determined according to a display resolution of the display screen 13. For example, when the display resolution of the display screen 13 is 1024×768, the width of the display size is 1024 pixels, and the height of the display size is 768 pixels.

In one example, if the height of the display size is defined as a, the width of the display size is defined as b, the height of the webpage is defined as c, the width of the webpage is defined as d, the position of the vertical scrollbar is defined as e, and the position of the horizontal scrollbar is defined as f, the a, b, c, d, e, and f may be obtained using the following programs:

a=document.body.clientHeight;

b=document.body.clientWidth;

c=document.body.scrollHeight;

d=document.body.scrollWidth;

e=document.body.scrollTop;

f=document.body.scrollLeft. In the embodiment, the position of the vertical scrollbar (e) is a distance from the vertical scrollbar to the top of the webpage. The position of the horizontal scrollbar (f) is a distance from the horizontal scrollbar to the left of the webpage.

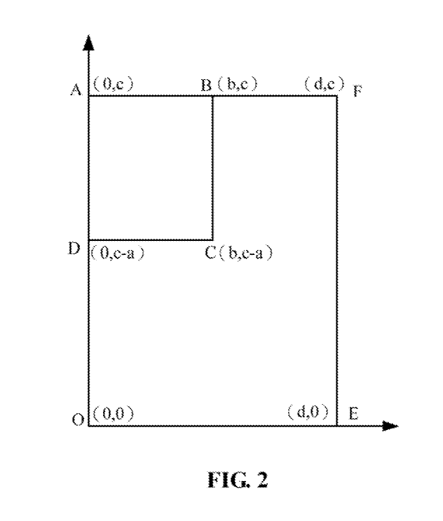

As shown in FIG. 2, an example of the webpage is defined by a rectangular area AOEF, where coordinates of points A, O, E, and F in the webpage respectively are (0, c), (0, 0), (d, 0), and (d, c), and A represents a left-top vertex of the display size of the display screen 13. Thereupon, the viewable area of the webpage is determined to be a rectangular area having the vertexes of (f, c-e), (f+b, c-e), (f+b, c-e-a), and (f, c-e-a). The initial viewable area of the webpage is a particular viewable area of the webpage upon the condition that the horizontal scrollbar and the vertical scrollbar have not been moved (e=0, and f=0). That is, the initial viewable area is a rectangular area having the vertexes of (0, c), (b, c), (b, c-a), and (0, c-a), which is the rectangle ABCD in FIG. 2.

The information request module 102 sends a request message to the network server 3 requesting information within the initial viewable area, and displays the requested information on the display screen 13 through the web browser 14. In the embodiment, other information of the webpage besides the information within the initial viewable area is not requested and not downloaded to the electronic device 1.

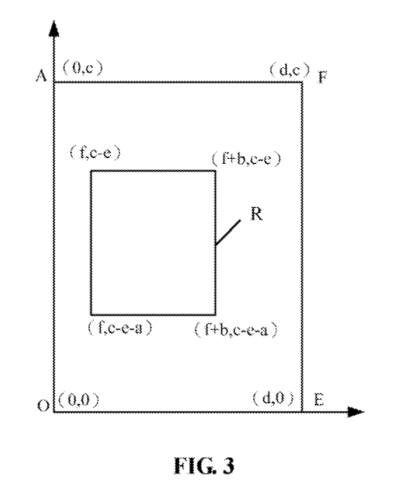

The scrollbar monitoring module 103 monitors movements of the horizontal scrollbar and the vertical scrollbar in real-time. When a movement of the horizontal scrollbar or the vertical scrollbar is monitored, the viewable area calculation module 101 further detects a current viewable area of the webpage. In one example, as shown in FIG. 3, when the horizontal scrollbar and the vertical scrollbar has been moved, the current viewable area of the webpage is a rectangular area R1 having the vertexes of (f, c-e), (f+b, c-e), (f+b, c-e-a), and (f, c-e-a).

The information update module 104 requests information within the current viewable area of the webpage from the network server 3, and updates the information displayed on the display screen 13 using the requested information. In the embodiment, other information present in other area outside the current viewable area of the webpage is not requested by the electronic device 1, so as to save network resources.

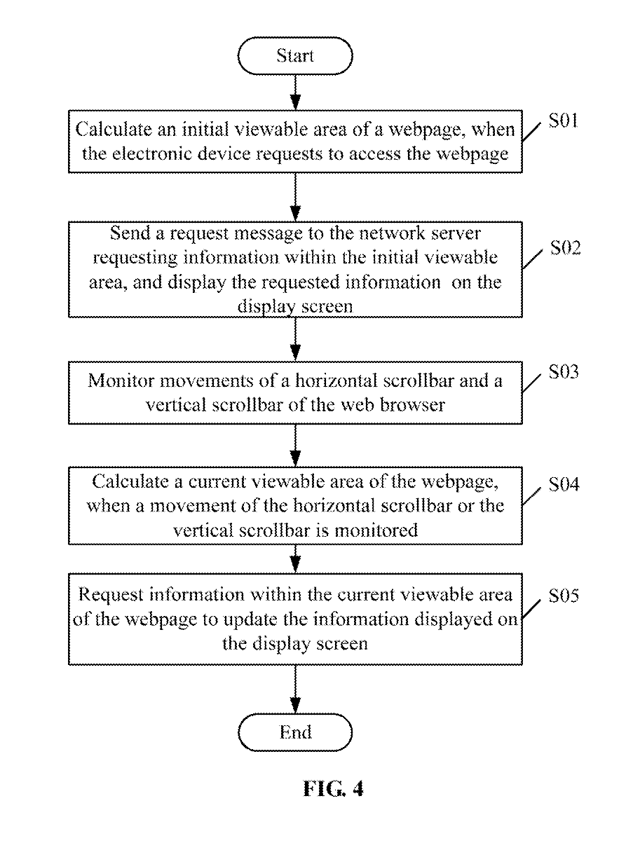

FIG. 4 shows a flowchart of one embodiment of a method for accessing information on the Internet using the electronic device 1 of FIG. 1. Depending on the embodiment, additional steps may be added, others removed, and the ordering of the steps may be changed.

In step S01, the viewable area calculation module 101 calculates an initial viewable area of a webpage to be displayed on the display screen 13, when the electronic device 1 requests to access the webpage from the network server 3 using the web browser 14.

In step S02, the information request module 102 sends a request message to the network server 3 requesting information within the initial viewable area, and displays the requested information on the display screen 13 through the web browser 14.

In step S03, the scrollbar monitoring module 103 monitors movements of the horizontal scrollbar and the vertical scrollbar of the web browser 14 in real-time.

In step S04, the viewable area calculation module 101 calculates a current viewable area of the webpage, when a movement of the horizontal scrollbar or the vertical scrollbar is monitored.

In step S05, the information update module 104 requests information within the current viewable area of the webpage from the network server 3, and updates the information displayed on the display screen 13 using the requested information within the current viewable area.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized method for accessing information on the Internet from a network server using an electronic device, the method comprising:
calculating an initial viewable area of a webpage to be displayed on a display screen of the electronic device, when the electronic device requests to access the webpage using a web browser;
sending a request message to the network server requesting information within the initial viewable area of the webpage, and displaying the requested information on the display screen through the web browser;
monitoring movements of a horizontal scrollbar and a vertical scrollbar of the web browser in real-time;
calculating a current viewable area of the webpage, when a movement of the horizontal scrollbar or the vertical scrollbar is monitored; and
requesting information within the current viewable area of the webpage from the network server, and updating the information displayed on the display screen using the requested information within the current viewable area.

2. The method according to claim 1, wherein the initial viewable area and the current viewable area are calculated according to a display size of the display screen, positions of the horizontal scrollbar and the vertical scrollbar in the webpage, and a width and a height of the webpage, where the display size of the display screen is defined as a rectangular screen space having a width and a height that is available to display data on the display screen when the webpage is accessed.

3. The method according to claim 2, wherein the initial viewable area of the webpage is a particular portion of the webpage to be firstly displayed on the display screen upon the condition that the horizontal scrollbar and the vertical scrollbar have not been moved.

4. The method according to claim 2, wherein the webpage is defined as a rectangular area formed by coordinate points of (0, c), (0, 0), (d, 0), and (d, c), and the initial viewable area is a rectangular area formed by coordinate points of (0, c), (b, c), (b, c-a), and (0, c-a) in the webpage, where a represents the height of the display size, b represents the width of the display size, c represents the height of the webpage, d represents the width of the webpage, and the coordinate point (0, c) represents a left-top vertex of the display size.

5. The method according to claim 4, wherein the current viewable area of the webpage is formed by coordinate points of (f, c-e), (f+b, c-e), (f+b, c-e-a), and (f, c-e-a), where e represents the position of the vertical scrollbar of the web browser in the webpage, and f represents the position of the horizontal scrollbar of the web browser in the webpage.

6. The method according to claim 5, wherein the position of the vertical scrollbar is defined as a distance from the vertical scrollbar to the top of the webpage, and the position of the horizontal scrollbar is defined as a distance from the horizontal scrollbar to the left of the webpage.

7. An electronic device communicating with a network server through a network, the electronic device comprising:
a display screen;
a web browser;
a storage device;
at least one processor; and
one or more programs stored in the storage device and executed by the at least one processor, the one or more programs comprising:
a viewable area calculation module that calculates an initial viewable area of a webpage to be displayed on the display screen, when the electronic device requests to access the webpage using the web browser;
an information request module that sends a request message to the network server requesting information within the initial viewable area of the webpage, and displays the requested information on the display screen through the web browser;
a scrollbar monitoring module that monitors movements of a horizontal scrollbar and a vertical scrollbar of the web browser in real-time;
the viewable area calculation module that further calculates a current viewable area of the webpage, when a movement of the horizontal scrollbar or the vertical scrollbar is monitored; and
an information update module that requests information within the current viewable area of the webpage from the network server, and updates the information displayed on the display screen using the requested information within the current viewable area.

8. The electronic device according to claim 7, wherein the initial viewable area and the current viewable area are calculated according to a display size of the display screen, positions of the horizontal scrollbar and the vertical scrollbar in the webpage, and a width and a height of the webpage, where the display size of the display screen is defined as a rectangular screen space having a width and a height that is available to display data on the display screen.

9. The electronic device according to claim 8, wherein the initial viewable area of the webpage is a particular portion of the webpage to be firstly displayed on the display screen upon the condition that the horizontal scrollbar and the vertical scrollbar have not been moved when the webpage is accessed.

10. The electronic device according to claim 8, wherein the webpage is defined as a rectangular area formed by coordinate points of (0, c), (0, 0), (d, 0), and (d, c), and the initial viewable area is a rectangular area formed by coordinate points of (0, c), (b, c), (b, c-a), and (0, c-a) in the webpage, where a represents the height of the display size, b represents the width of the display size, c represents the height of the webpage, d represents the width of the webpage, and the coordinate point (0, c) represents a left-top vertex of the display size.

11. The electronic device according to claim 10, wherein the current viewable area of the webpage is formed by coordinate points of (f, c-e), (f+b, c-e), (f+b, c-e-a), and (f, c-e-a), where e represents the position of the vertical scrollbar of the web browser in the webpage, and f represents the position of the horizontal scrollbar of the web browser in the webpage.

12. The electronic device according to claim 11, wherein the position of the vertical scrollbar is defined as a distance from the vertical scrollbar to the top of the webpage, and the position of the horizontal scrollbar is defined as a distance from the horizontal scrollbar to the left of the webpage.
